(19) United States
(12) Patent Application Publication
(10) Pub. No.: US 2009/0187323 A1
(43) Pub. Date: Jul. 23, 2009

(54) METHOD FOR IMPROVING THE OVERTURNING BEHAVIOR OF VEHICLES WITH THE AID OF REAR AXLE INTERVENTION

(76) Inventors: Ernst Schermann, Ludwigsburg (DE); Daniel Fellke, Stuttgart (DE); Gero Nenninger, Tamm (DE); Matthew Nimmo, Ludwigsburg (DE)

Correspondence Address: KENYON & KENYON LLP, ONE BROADWAY, NEW YORK, NY, 10004, US

(21) Appl. No.: 12/300,455

(22) PCT Filed: Apr. 3, 2007
(86) PCT No.: PCT/EP2007/053215

§ 371 Date: Nov. 11, 2008

(30) Foreign Application Priority Data
May 19, 2006 (DE) 102006023700.5
Oct. 9, 2006 (DE) 102006047652.2

(51) Int. Cl. B60T 8/1755

(52) U.S. Cl. 701/72

(57) ABSTRACT

A method for improving the overturn behavior of vehicles in which in an imminent or predictably expected overturn risk at least the rear wheel on the outside of the curve is braked, in an imminent or predictably expected overturn risk the rear wheel on the outside of the curve being braked using a braking force which is a function of the transverse acceleration.

### RELATED APPLICATION INFORMATION

The present application is a United States national phase patent application and claims the benefit of and priority to International Application No. PCT/EP2007/0053215, which was filed Apr. 3, 2007, and which claims the benefit of and priority to German Patent Application No. 10 2006 023 700.5, which was filed in Germany on May 19, 2006, and which claims the benefit of and priority to German Patent Application No. 10 2006 047 652.2, which was filed in Germany on Oct. 9, 2006, all of which are incorporated by reference.

### FIELD OF THE INVENTION

The field of the invention relates to a method for improving the overturn behavior of vehicles, in which in the event of an imminent or predictably expected overturn risk at least the rear wheel on the outside of the curve is braked, wherein, in the event of an imminent or predictably expected overturn risk, the rear wheel on the outside of the curve is braked using a braking force which is a function of the transverse acceleration.

### BACKGROUND INFORMATION

In vehicles having a high center of gravity such as SUVs or minivans, a risk of overturning, caused by the high transverse acceleration, exists on non-skid roads and in the event of sudden steering interventions using high steering gradients and/or high steering angles.

U.S. Pat. No. 6,605,558 discusses an overturn prevention system in which a sensor emits an overturn signal in response to a predefined force tending to overturn the vehicle. In the presence of the overturn signal, either both front wheel brakes or the front wheel brake associated with the wheel having the highest wheel load are applied.

In German patent document DE 196 32 943 A1, an overturn-stabilizing brake intervention on both wheels on the outside of the curve is proposed. In this document, however, there is no recommendation regarding the intensity of the intervention either on the front or on the rear axle.

### SUMMARY OF THE INVENTION

The exemplary embodiments and/or exemplary methods of the present invention relates to a method for improving the overturning behavior of vehicles in which in the event of an imminent or predictably expected overturn risk at least the rear wheel on the outside of the curve is braked, in the event of an imminent or predictably expected overturn risk the rear wheel on the outside of the curve being braked using a force which is a function of the transverse acceleration. The transverse acceleration is the transverse acceleration acting on the vehicle. This not only reduces the likelihood of overturning, but also improves the driving dynamics of the vehicle and the comfort in this situation. The intervention on the rear wheel on the outside of the curve results in the following advantages:
Maximum possible yaw rate reduction and thus stronger transverse acceleration reduction.
The increase in rolling stability due to the intervention on the rear wheel on the outside of the curve allows weaker intervention on the front outer [wheels], which in turn may enhance the steerability of the vehicle during the intervention and is more comfortable for the driver.
The vehicle velocity is reduced more intensively by braking the two wheels on the outside of the curve than by braking only the front outer [wheel], which results in a stronger reduction in the transverse acceleration and reduces the kinetic energy of the vehicle.

An advantageous embodiment of the present invention is characterized in that
the maximum generatable, stabilizing yaw moment is ascertained for the rear wheel on the outside of the curve, and
the rear wheel on the outside of the curve is braked in such a way that the maximum stabilizing yaw moment is generated.

An optimally stabilizing effect is thus achieved due to the rear wheel braking. An advantageous embodiment of the present invention is characterized in that
a slip angle, at which the transmissible lateral force is at a maximum, is determined from a tire characteristics curve;
a setpoint value for the brake slip at which the yaw moment generated by the braking of the rear wheel on the outside of the curve is at a maximum is ascertained from this slip angle and from parameters which are a function the vehicle geometry;
the rear wheel on the outside of the curve is braked in such a way that this brake slip sets in.

An advantageous embodiment of the present invention is characterized in that the transverse acceleration is used as an input parameter for the tire characteristics curve. The tire characteristics curve may be a generic tire characteristics curve.

An advantageous embodiment of the present invention is characterized in that in the event of an imminent or predictably expected risk of overturn, the front wheel on the outside of the curve is additionally braked.

Furthermore, the exemplary embodiments and/or exemplary methods of the present invention includes a device containing an arrangement for carrying out the above-described methods.

### BRIEF DESCRIPTION OF THE DRAWINGS

FIG. 1 shows the variation of the coefficient of friction in the longitudinal direction is plotted on the ordinate against brake slip λB plotted on the abscissa.

FIG. 2 qualitatively shows the variation of yaw moment M_{Gi,HAA} from the rear outer wheel about the center of gravity.

FIG. 3 shows that the maximum yaw moment results as a function of the brake slip when the lever arm about the vehicle's center of gravity and the resulting force become maximum.

In FIG. 4, the measurements show that for P_RMFRearAxleBoost values 1 and 4 the transverse acceleration is (like the vehicle velocity) significantly reduced with respect to the zero value (no intervention on the rear wheel on the outside of the curve).

In FIG. 5, the measurements show that for P_RMFRearAxleBoost values 1 and 4 the vehicle velocity is (like the transverse acceleration) significantly reduced with respect to the zero value (no intervention on the rear wheel on the outside of the curve).

FIG. 6 shows the sequence of the method according to the present invention.

### DETAILED DESCRIPTION

In the exemplary embodiments and/or exemplary methods of the present invention described below, the stabilizing brake intervention takes place on both wheels on the outside of the curve; a definition of the intervention intensities on the rear axle that are advantageous from the point of view of vehicle dynamics is described. The specific selection of the intervention intensity which is calculated individually for the front and rear wheels not only reduces the likelihood of overturning, but also improves the driving dynamics of the vehicle and the comfort in this overturn risk situation.

An idea of the exemplary embodiments and/or exemplary methods of the present invention is the recognition that in an overturn-critical situation it is useful to decelerate both the front wheel on the outside of the curve and the rear wheel on the outside of the curve which may be by optimum brake interventions. The main object is to achieve a more rapid transverse acceleration reduction through the higher braking effect and a better distribution of the braking forces to both wheels on the outside of the curve and thus to quickly eliminate the risk of overturning and quickly stabilize the vehicle.

The transverse acceleration resulting in overturning is a function of the vehicle velocity and the instantaneous radius of curvature of the road curve on which the vehicle is negotiating. The relevant formula is the following:

$${a}_{Q} = \frac{{v}^{2}}{ρ} = v ( \dot{β} + \dot{ψ} ) ,$$

where aQ is the transverse acceleration, v is the vehicle velocity, p is the radius of curvature of the road curve, β is the float angle, and ψ is the yaw angle of the vehicle. Thus, the transverse acceleration is ultimately the function of the vehicle velocity and the sum of the variations of the float and yaw angles over time. Therefore, to reduce the transverse acceleration as effectively and rapidly as possible in an overturn-critical situation, the vehicle velocity and, mainly, the variation of the float angle and yaw angle (yaw rate) over time must be rapidly reduced.

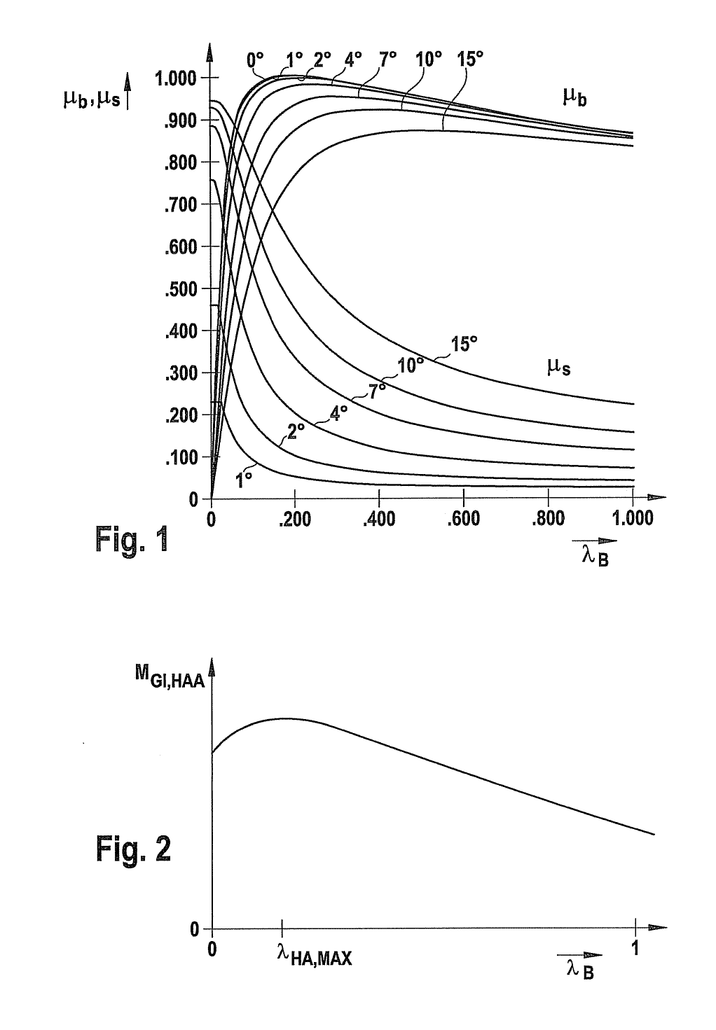

In the curve, the major portion of the vehicle mass is supported by the wheels on the outside of the curve due to the so-called dynamic wheel load distribution. These wheels thus essentially transfer the reducible braking and lateral forces. For the maximum possible reduction of the lateral force and thus of the transverse acceleration, the wheels on the outside of the curve therefore must be braked as intensively (i.e., up to locking the wheels) as possible. This is shown in FIG. 1, where the variation of the coefficient of friction in the longitudinal direction is plotted on the ordinate against brake slip λB plotted on the abscissa. The curves are drawn for different slip angles measured in degrees over the different characteristics curves. In the direction of the ordinates, μb denotes the coefficient of friction in the longitudinal direction and μs denotes the coefficient of friction in the transverse direction.

The slip angles in degrees (1°, 2°, 4°, 7°, 10°, 15°) are shown as parameters next to the corresponding curves.

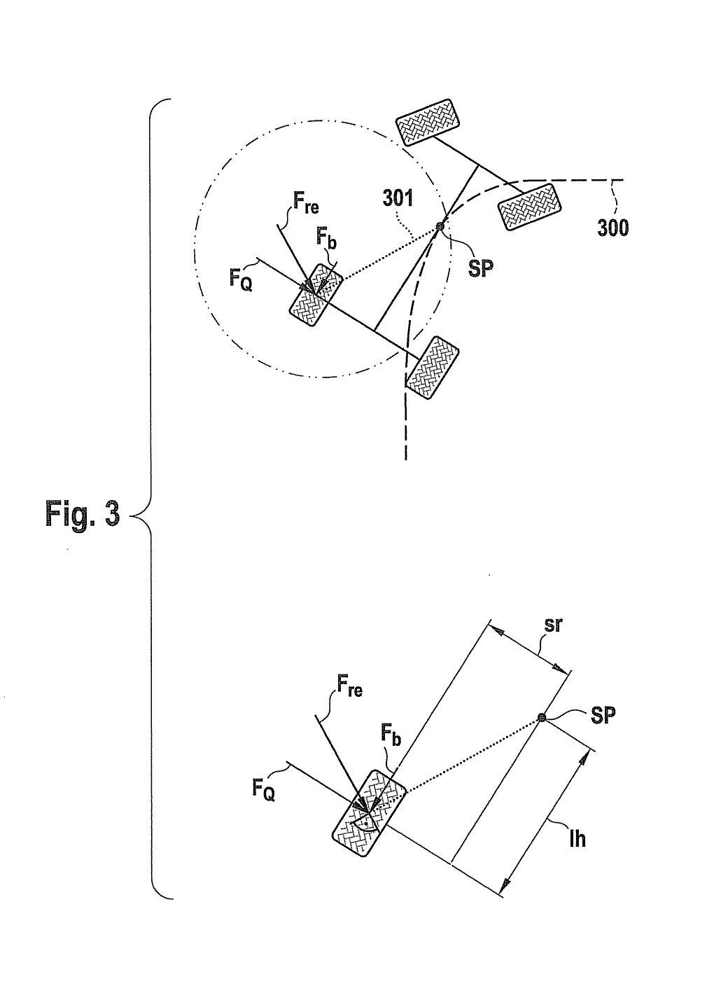

FIG. 2 qualitatively shows the variation of yaw moment M_{Gi,HAA} from the rear outer wheel about the center of gravity. For this purpose, brake slip λB is plotted in the direction of the abscissa, while yaw moment M_{Gi,HAA} caused by this brake slip is plotted in the direction of the ordinate. λ_{MA,MAX} denotes the brake slip at which yaw moment M_{Gi,HAA} assumes its maximum value.

The rear outer wheel should be braked in an overturn-critical situation in such a way that a maximum stabilizing (i.e., rotating out of the curve) yaw moment originating from this wheel is achieved. This is the case when the vector of the forces acting on the wheel (the sum of lateral force and braking force) is perpendicular to the line connecting the point of contact of the wheel with the road and the vehicle's center of gravity. The yaw rate is reduced or the curve radius is increased by the stabilizing yaw moment, which reduces the transverse acceleration.

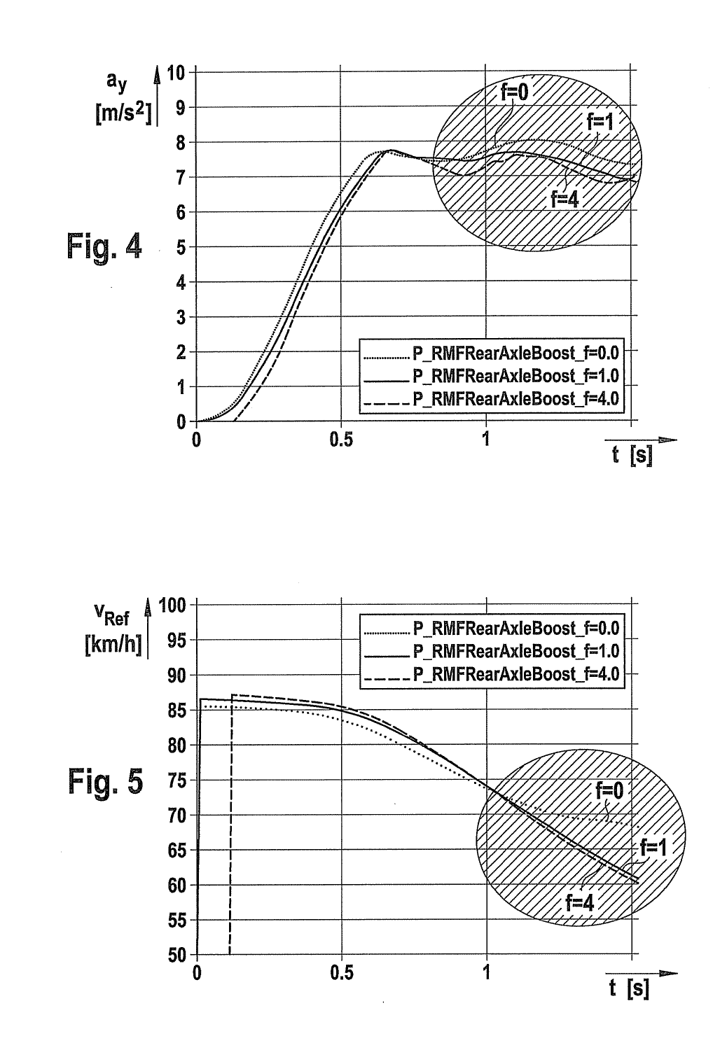

The maximum yaw moment results as a function of the brake slip when the lever arm about the vehicle's center of gravity and the resulting force become maximum. This is shown in FIG. 3, where 300 denotes the trajectory of the vehicle, SP denotes the center of gravity, and 301 denotes the line connecting the point of contact of the wheel with the road to the center of gravity of the vehicle. F_{b} denotes the braking force, F_{Q} the lateral force, and Fᵣₑ the sum of these two forces. The vector Fᵣₑ is perpendicular to connecting line 301.

The brake slip, which causes this maximum resulting force, may be calculated as follows:

$${λ}_{HA , max} = \frac{sr}{lh} {α}_{HA , max} ,$$

where λ_{HA,max} is the required brake slip, sr is the half-width of the lane, lh is the distance parallel to the vehicle axis between the center of gravity of the vehicle and the point of contact of the rear wheel with the road, and α_{HA,max} is the required slip angle. The slip angle is determined from the tire characteristics curve. For a brake slip thus established, the stabilizing yaw moment is maximum. The yaw rate is thus reduced (or the road radius is increased) and thus the transverse acceleration and therefore the likelihood of overturning is reduced.

Another advantage of the exemplary embodiments and/or exemplary methods of the present invention is the more rapid velocity reduction, which has been evidenced by driving tests. This is shown in FIG. 5, where time t is plotted along the abscissa and the longitudinal vehicle velocity along the ordinate.

The transverse acceleration is thus also reduced. In addition, understeering is minimized in that the velocity is more rapidly reduced to a value at which the vehicle again follows the intended steering. If nevertheless an accident occurs despite the evading maneuver, a reduced velocity has finally the advantage that the risk of injury to the vehicle's occupants is reduced due to the reduced kinetic energy.

Setting the brake slip in a properly regulatable (linear) slip range is also advantageous. This makes rapid reduction of the vehicle velocity possible, which in turn reduces the transverse acceleration.

It is also possible to set a brake slip by maximizing the lever arm. Although the stabilizing yaw moment is again reduced with respect to the yaw moment maximum, the lateral force and thus the transverse acceleration is reduced even more via Kamm's circle.

In a special specific embodiment, the setpoint slip on the rear wheel on the outside of the curve is given by a factor P_RMFRearAxleBoost multiplied by the above-mentioned maximum slip λ_{HA,max}, and the wheel slip is set by a lower-level slip regulator. The effects of the settings P_RMFRearAxleBoost=[0, 1, 4] on the variation of transverse acceleration and vehicle deceleration over time are compared with each other in a vehicle test (see FIGS. 4 and 5). The measurements show that for P_RMFRearAxleBoost values 1 and 4 both the transverse acceleration (see FIG. 4) and the vehicle velocity (see FIG. 5) are significantly reduced with respect to the zero value (no intervention on the rear wheel on the outside of the curve). This reduces the risk for overturning, accident, and injury.

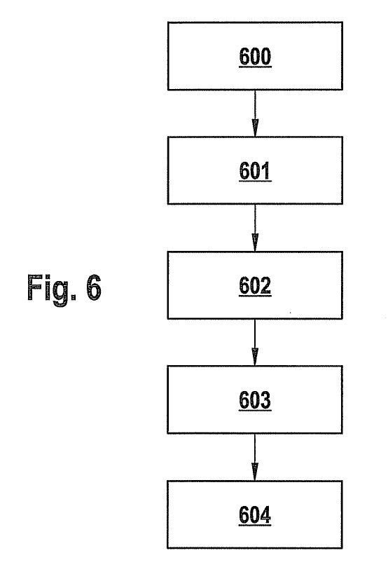

FIG. 6 shows the sequence of the method according to the present invention. After a start in block 600, in block 601 a slip angle at which the transmissible lateral force is at a maximum is determined from a tire characteristics curve. In block 602 a setpoint value for the brake slip at which the yaw moment generated by the braking of the rear wheel on the outside of the curve is at a maximum is ascertained from this slip angle and from parameters which are a function of the vehicle geometry. Subsequently in block 603 the rear wheel on the outside of the curve is braked in such a way that this brake slip sets in. The method according to the present invention is terminated in block 604.

1-7. (canceled)

8. A method for improving an overturn behavior of a vehicle, the method comprising:
braking, in the event of an imminent or predictably expected overturn risk, at least a rear wheel on an outside of the curve, wherein, in the event of the imminent or the predictably expected overturn risk, the rear wheel on the outside of the curve is braked using a braking force which is a function of the transverse acceleration.

9. The method of claim 8, wherein a maximum generatable, stabilizing yaw moment is ascertained for the rear wheel on the outside of the curve, and the rear wheel on the outside of the curve is braked so that a maximum stabilizing yaw moment is generated.

10. The method of claim 8, further comprising:
determining a slip angle, at which a transmissible lateral force is at a maximum, from a tire characteristics curve;
determining a setpoint value for the brake slip, at which the yaw moment generated by the braking of the rear wheel on the outside of the curve is at a maximum is ascertained, from this slip angle and from parameters which are a function of a vehicle geometry; and
braking the rear wheel on the outside of the curve is braked so that the brake slip sets in.

11. The method of claim 10, wherein the transverse acceleration is used as an input parameter for the tire characteristics curve.

12. The method of claim 8, wherein the tire characteristics curve is a generic tire characteristics curve.

13. The method of claim 8, wherein in the event of an imminent or predictably expected overturn risk, the front wheel on the outside of the curve is additionally braked.

14. A device for improving an overturn behavior of a vehicle, comprising:
a braking arrangement for braking, in the event of an imminent or predictably expected overturn risk, at least a rear wheel on an outside of the curve, wherein, in the event of the imminent or the predictably expected overturn risk, the rear wheel on the outside of the curve is braked using a braking force which is a function of the transverse acceleration.
